(19) United States
(12) Patent Application Publication
(10) Pub. No.: US 2010/0112881 A1
(43) Pub. Date: May 6, 2010

(54) Composite material and method for manufacturing composite material

(76) Inventor: Pradip Bahukudumbi, Greenville, SC (US)

Correspondence Address: Legal Department (M-495), P.O. Box 1926, Spartanburg, SC, 29304, US

(21) Appl. No.: 12/290,734

(22) Filed: Nov. 3, 2008

(51) Int. Cl. B32B 27/12; B27N 3/00

(52) U.S. Cl. 442/1; 428/343; 264/112

(57) ABSTRACT

In one embodiment of the invention, an improved composite component is provided. A more efficient and improved manner of adhesive application for the manufacture of fibrous composite molded components is achieved. This results in improved finished molded parts having therein a sintered powdered adhesive layer. The manner of applying non-contact heat to the adhesive while in place on the core layer sinters the powder adhesive, enabling the sintered powdered adhesive to stay on the surface, without undesirable migration to the interior of a porous fibrous composite structure. The stability of the adhesive on the surface of the composite after heating at elevated temperatures is one feature of the invention.

### BACKGROUND OF THE INVENTION

Automotive headliners and other related interior trim components may be manufactured from thermoformable composite substrates. The construction of most automotive interior headliners requires an adhesive material to bond a polyurethane foam-backed decorative fabric to a molded headliner surface. Traditionally, polymer films or spun bond adhesive scrims have been used for this purpose. The adhesive may be pre-applied to the foam-backed fabric or upon the composite substrate to improve fabrication efficiency. Recent advancements in headliner designs include more modularity, such as additional recessed areas with more demanding contours. As a result, the automotive market has seen considerable changes in substrate materials used for headliners. Furthermore, efforts are underway in the automotive parts industry to reduce the weight of components in automobiles. This effort may be directed to reducing the weight of interior trim components. For environmental and recycling reasons, there is also a growing trend towards avoiding the use of glass in such components. This may be due to environmental disadvantages and worker safety issues related to the handling of fiberglass. Materials that are glass-free, lightweight, and inexpensive with high bending strength are highly desirable.

Acoustic properties of automobile interior trim components are becoming increasingly important. For an automobile to provide a quiet interior during use it is necessary for interior accessories to absorb and attenuate sound in a desired manner. This requires engineered composite substrates with the correct combination of thickness, density and air-flow resistance. If the composite substrates used to manufacture interior components are non-porous, they tend to reflect sound rather than absorb sound, and this is undesirable. Accordingly, it would be desirable to provide a composite substrate having optimized sound absorbing characteristics that can be molded to a desired shape for interior trim applications. It would be desirable to provide a sound absorbing moldable composite in which a decorative foam-fabric laminate is bonded to its surface during the molding process without forming a barrier to sound waves and without compromising acoustic performance. The present invention discloses the use of a sintered adhesive layer to acoustically couple the molded composite sheet and the decorative fabric layer.

Natural fibers have been disclosed for use in automotive parts. In general, natural and cellulosic fibers are lightweight and relatively inexpensive. However, it has been found when molding parts containing natural fibers that there may be significant processing limitations. It is necessary to overcome such limitations before the full potential of natural fiber parts may be realized. When a composite material with natural fibers is placed in a mold and pressed against a fabric-foam layer to form a molded part, the maximum temperature of the molding process is limited. In general, natural fiber-containing parts may not be heated to temperatures in excess of about 375-400 degrees F. At temperatures within or beyond that range, the natural fibers may burn or become scorched.

In molding activities that are designed to facilitate heat transfer from the composite to cold adhesive applied on the decorative fabric, it has been observed that natural fiber components are not efficient at transferring enough heat to reach the bond line temperature required for optimum adhesion. The maximum processing temperature limitation for natural fiber composites coupled with the heat loss that occurs as the heated composite exits the oven and is transferred to the molding station, makes it challenging to achieve satisfactory adhesion at reduced cycle times especially with deep contoured parts. This is less of an issue in glass containing composites as they can be heated to much higher temperatures. It is therefore desirable to provide a robust on-board adhesive solution for porous fiber containing composites that can widen the processing window during molding and maximize adhesion with decorative fabric layers.

This invention is directed towards addressing and overcoming challenges in the industry.

### BRIEF DESCRIPTION OF THE DRAWINGS

FIGS. 1-2 show a schematic flow diagram of one manner of practicing the invention;

FIG. 3 is an elevation view of an apparatus suitable for performing the method described in the current specification;

FIG. 4 illustrates the remainder of the manufacturing steps; and

FIGS. 5-13 show various embodiments of the invention;

FIG. 14 shows fibrous composites with patterned deposition of adhesive powder; and

FIGS. 15-16 show normal sound absorption coefficients for components of the invention.

### DETAILED DESCRIPTION OF THE INVENTION

In the invention, a more efficient and improved manner of adhesive application for porous substrates is achieved that results in desirable and cost effective finished molded parts. A powder adhesive layer sintered onto a porous substrate is used in the practice of the invention. In the context of this invention, “sintering” refers generally to the formation of an adhesive layer from powder, and usually involves heating the adhesive using non-contact heat until the particles adhere to each other and onto the porous substrate.

In one embodiment, the invention comprises a porous unitary fibrous composite material comprising a core layer of thermoplastic binder fibers and structural fibers. The core layer may have a first side and a second side, with a sintered powdered adhesive upon the core layer. The sintered powdered adhesive may be located upon the first side of the core layer. In other embodiments, the sintered powdered adhesive is located upon the second side of the core layer.

In a further embodiment of the invention, the first side is comprised in part of fine denier thermoplastic binder fibers, the second side is comprised in part of coarse denier thermoplastic binder fibers. The first side is substantially uniform, and a functional fiber concentration gradient extends from the first side to the second side of the core layer, wherein the porosity of the first side of the core layer is less than the porosity of the second side of the core layer. The structural fibers may comprise bast fibers. In some instances, a fabric-foam laminate structure is adhered to the first side of the core layer. The sintered powdered adhesive is positioned substantially between the fabric-foam laminate and the core layer. In some embodiments, the fabric-foam laminate structure may be adhered to the second side of the core layer, wherein the sintered powdered adhesive is positioned substantially between the fabric-foam laminate and the core layer. In some applications, a scrim is applied upon the core layer. For some applications, a fabric-foam laminate structure is adhered to the scrim upon the second side of the core layer such that the sintered powdered adhesive is positioned substantially between the fabric-foam laminate and the core layer. In some embodiments, the sintered powdered adhesive comprises at least two different chemical components. The chemical components may be selected from the group of polymers or copolymers consisting of: polyethylene, polypropylene, polystyrene, polyvinylchloride, polyethylene terephthalate, polycarbonate, and polyamide. The core layer may comprise a predetermined usage zone and a predetermined waste zone, the sintered powdered adhesive being located substantially completely upon the predetermined usage zone.

A method of making a porous fibrous unitary composite is shown, which may employ the following steps:
(a) providing thermoplastic binder fibers and structural fibers;
(b) blending the thermoplastic binder fibers and structural fibers to produce a fiber blend;
(c) applying the fiber blend to a conveyor;
(d) heating and compressing the fiber blend to form a core layer;
(e) depositing powdered adhesive upon the core layer; and
(f) sintering the powdered adhesive.

The structural fibers may be bast fibers. The core layer may comprise a first side and a second side, further wherein a functional fiber concentration gradient extends from the first side to the second side of the core layer, wherein the porosity of the first side is less than the porosity of the second side. In some cases, the sintered powdered adhesive is applied to the first side of the core layer. The sintered powdered adhesive may be applied to the second side of the core layer. A further step of applying a fabric-foam laminate upon the first side, or the second side, of the composite may be practiced as well. The core layer may comprises a predetermined usage zone for deposit of powdered adhesive and a predetermined waste zone that does not receive such powdered adhesive. The amount of sintered powdered adhesive deposited upon the core layer may be in the range of about 10-250 g/m². The sintering step typically employs a non-contact heating source.

The sintering of the adhesive avoids undesirable migration of adhesive into the interior of the porous composite during molding of the composite material and assists in maximizing the amount of adhesive available across the bond line for surface adhesion. The adhesive desirably remains in position for bonding when the heated composite is subsequently attached to a decorative foam or fabric layer in a molding station.

A porous unitary fibrous composite material comprises a core layer containing thermoplastic binder fibers and relatively high modulus structural fibers. The high modulus structural fibers typically have a modulus greater than 1 GPa, substantially greater than the thermoplastic binder fibers, and may include bast fibers, carbon fibers or glass fibers. The core layer has a first side and a second side. In a preferred embodiment, the first side may be comprised in part of fine denier thermoplastic binder fibers. The second side may be comprised in part of coarse denier thermoplastic binder fibers. The first side is substantially uniform and smooth. A functional fiber concentration gradient extends from the first side to the second side of the core layer, in one embodiment of the invention. The porosity of the first side of the core layer is less than the porosity of the second side of the core layer in some applications. In a preferred embodiment, bast fibers are dispersed in the thermoplastic matrix to reinforce the composite.

The term “bast fiber” refers to strong woody fibers obtained from the phloem of plants. Suitable bast fibers include, but are not limited to, jute, kenaf, hemp, flax, ramie, roselle, bamboo and combinations thereof. Other suitable bast fibers include, but are not limited to, leaf fibers (e.g., fibers derived from sisal, banana leaves, grasses (e.g., bamboo), or pineapple leaves), straw fibers (e.g., fibers derived from wheat straw, rice straw, barley straw, or sorghum stalks), bamboo fibers, and husk fibers (e.g., fibers derived from corn husk, bagasse (sugar cane), or coconut husk). In certain embodiments, the bast fiber may be jute. The fiber-containing composite can contain any suitable amount of the bast fiber(s). For example, the bast fibers can comprise about 30 to about 70 wt. %, about 30 to about 60 wt. %, or about 60 wt. % of the total weight of the fiber-containing composite. The bast fibers suitable for use in the disclosed fiber-containing composite and method can have any suitable linear density (i.e., denier). For example, the bast fibers can have a linear density of about 8. 8̅ dtex (8 denier) to about 20 dtex (18 denier).

The binders contained in the fiber-containing composite can be any suitable binder material. For example, the binder materials may be thermoplastic materials capable of at least partially melting when heated so that the fibers contained within the composite will be wetted, encapsulated, and bonded together. Suitable thermoplastic binder materials include, but are not limited to, polyesters (e.g., polyethylene terephthalate (PET) or glycol-modified PET (PETG)), polyamides (e.g., nylon 6 or nylon 6,6), polyethylenes (e.g., high density polyethylene (HDPE) or linear low density polyethylene (LLDPE)), polypropylenes, polylactic acid, poly(1,4-cyclohexanedimethylene terephthalate) (PCT), and combinations thereof. Suitable binder fibers also include, but are not limited to, bicomponent binder fibers (e.g., bicomponent binder fibers comprising a thermoplastic sheath) and thermoplastic binder fibers having a relatively low melt flow rate. Suitable bicomponent fibers include bicomponent, sheath-core fibers in which the sheaths have a lower melting point than the cores of the fibers. For example, the bicomponent, sheath-core fiber can have a polyethylene sheath (e.g., a high density polyethylene sheath) and a polypropylene or polyester core. Other suitable bicomponent fibers include fibers having a PET copolymer sheath and a PET core, a PCT sheath and polypropylene core, a PCT sheath and a PET core, a PETG sheath and a PET core, a HDPE sheath and a PET core, a HDPE sheath and a polypropylene core, a LLDPE sheath and a PET core, a polypropylene sheath and a PET core, or a nylon 6 sheath and a nylon 6,6 core. When such fibers are used in the disclosed composite, the composite can be heated so that the sheaths of the bicomponent fibers are melted to provide links between adjacent fibers within the composite, while the cores of the bicomponent fiber retain their fibrous structure. As noted above, the binder fibers can be thermoplastic binder fibers in which the thermoplastic material has a relatively low melt flow rate. For example, the melt flow rate of the thermoplastic fibers can be about 18 g/10 min. or less (e.g., about 8 g/10 min.), as determined in accordance with, for example, ASTM Standard D1238 entitled “Standard Test Method for Melt Flow Rates of Thermoplastics by Extrusion Plastometer.” When such fibers are used in the disclosed composite, the composite may be heated so that the thermoplastic binder fibers are at least partially melted to provide links between adjacent fibers, while the relatively low melt flow rate of the thermoplastic material allows the binder fibers to retain their fibrous structure.

The binder fibers contained in the fiber-containing composite may be of any suitable linear density or combination of linear densities. In certain embodiments, each of the different binder fiber types contained in the composite can have different linear densities. “Fine denier” thermoplastic fibers refers to fibers having a denier less than about 10 denier, in one embodiment. “Coarse denier” thermoplastic fibers refers to fibers of greater than about 30 denier, in another embodiment. In yet another embodiment, fine denier refers to fibers of denier less than about 5 denier, with coarse denier being fibers of denier greater than about 50 denier.

A powder adhesive layer may be sintered upon either (i) the first side or (ii) the second side of the core layer, depending upon the particular application. For some embodiments of the invention, the more porous second side of the composite may require a scrim layer. When a scrim is used in such applications, powdered adhesive may be applied onto the scrim. This may be followed by sintering with non-contact heat. In other applications, the more porous second side of the core layer may not require a scrim layer, and powdered adhesive may be sintered directly upon the second side of the core layer. In one embodiment of the invention, no scrim is required on the first side to hold the powdered adhesive on the surface, due to the low porosity and minimal surface roughness of the first side. The size of the powder adhesive was carefully chosen to be greater than the pore size on the second surface when a scrim layer was not used. The sintered powder adhesive provides partial coverage of the composite surface and does not render the surface impermeable to air.

The sintered powdered adhesive may be selected from the group of adhesives consisting of: polyamide, olefin-based, and polyester-based adhesives. The amount of sintered powdered adhesive deposited upon the core layer may be in the range of about 10-250 g/m², and in other embodiments may be in the range of about 20-150 g/m². One type of adhesive that may be employed is Griltex D 1556A P1-5 adhesive, a co-polyamide hot melt adhesive manufactured and distributed by EMS-Griltech Americas of Sumter, S.C. (“Griltex”). About 60 gram/m² of adhesive powder may be used to achieve a good bond between the composite substrate and decorative fabrics, but the concentration of adhesive powder added may range anywhere from 10-250 gram/m², or in other embodiments, 20-150 gram/m². The powder adhesive used is fairly poly-disperse. That is, only about 2% of the powder is in the size range 0-63 micrometers, about 38-65% of the powder is in the size range of about 63-200 micrometers, about 34-60% of the powder is in the size range 200-500 micrometers, and about 1% of the powder is in the size range 500-630 micrometers. The melting point of the Griltex adhesive measured using Differential Scanning Calorimetry is about 140 Centigrade. This particular adhesive has an average melt viscosity of about 500 Pa sec. The average moisture content is less than about 2.5%.

In one application of the invention, more than one species of adhesive may be employed. Adhesive chemical components may be selected from the group consisting of: polyethylene terephthalate, polypropylene, polyamides, co-polyamides and co-polyesters, olefin-based polyester-based, and one or more of these may be employed. In applications of more than one type of adhesive to the composite substrate, polymeric powders that are immiscible can be employed. Further, one of the powders could have a low tack time and require a high bond line temperature, and the other adhesive could have a longer tack time and a lower bond line temperature. This could widen the “processing window” for bonding the decorative fabric to the substrate, and may also assist in controlling costs.

In some applications of the invention, it is possible to reduce the total amount of adhesive employed and product costs by using patterned deposition of the powdered adhesive on only the portions of the core layer that are likely to become the finished part. In this way, it is possible to avoid wasting adhesive on portions that become waste materials following trimming operations. This attribute of the invention has applications, for example, in modular automotive headliners with sunroofs, wherein almost 30 percent of the composite substrate that is molded is trim waste.

The porous composite substrate described above can be used in, but not limited to, automotive headliners, door panels, package trays, cargo management trim, seat backs, and other such applications. The composite substrate can be molded using methods well known in the art, for example, thermal forming, compression forming, and vacuum forming. A decorative fabric layer is generally attached to the sintered powder adhesive side of the core layer during the molding step. The decorative fabric layer typically is either a non-woven needle punched thermoplastic fiber material or a knit/woven textile with a foam backing. In some applications, the decorative fabric may be applied to the second side, i.e. the more porous and “rough” side of the core layer. In that instance, the sintered powdered adhesive is positioned substantially between the fabric layer and the core layer. When the second surface has a scrim, the sintered powdered adhesive is positioned substantially between the fabric layer and the scrim.

A method is shown for making a porous fibrous unitary composite by providing thermoplastic binder fibers and high modulus fibers and then blending the fibers to produce a fiber blend. This process may employ a method of laying fibers of differential fiber density and/or weight, so that a functional gradient is provided across the thickness of the core layer from the first side to the second side. This refers, in that particular embodiment, to a change in concentration of fine denier (or coarse denier) fibers across the width of the core layer. This is illustrated and described in detail in United States Patent Publication US 2007/0042664 A1 to Thompson et al, the disclosure of which is incorporated by reference herein. Of course, the invention is not limited to the use of such functionally graded materials, and the invention may be practiced with materials that are homogenous in fiber disposition across the thickness. A method is also shown to sinter powder adhesives onto the porous composite surface using non-contact heat. In some methods, the powdered adhesive is heated using non-contact heating to a temperature of at least about 350 degrees F., depending upon which type of adhesive is employed. Non-contact heating may be applied using infrared heating devices, in one embodiment. Non-contact heating facilitates the softening of the particles on their exterior surface without completely melting the adhesive particle core, thereby fusing the adhesive paricles to fibers on the surface, keeping the particles of adhesive in place on the surface and positioned for adhesion. The invention avoids the undesirable migration of adhesive down into the porous composite, which causes the adhesive to be unavailable for performing its intended purpose of adhering the composite to the fabric or foam laminate.

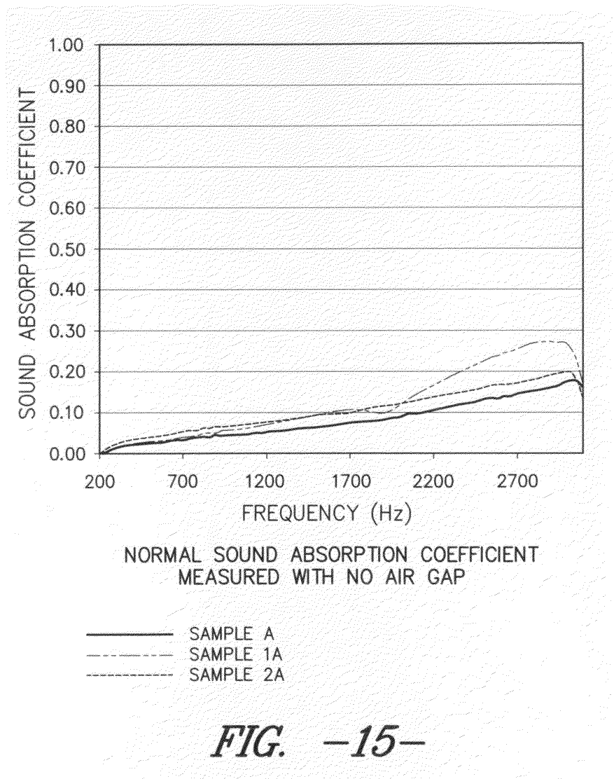

The use of powdered adhesives also makes it possible to prepare a patterned deposition (See FIG. 14) of adhesive upon the core layer using a precision scattering machine with a master rotary screen. This is not feasible, and is cost prohibitive, when adhesive films are employed. In one embodiment, the core layer may comprise a predetermined usage zone for deposition of powdered adhesive and a predetermined waste zone which does not receive any powdered adhesive. The waste zone is later cut from the molded part, and the waste zone portion does not require adhesive bonding between the core layer and the fabric-foam laminate. The predetermined usage zone can be of any defined size and shape and can be accurately controlled.

Patterned deposition of adhesive powder using a master rotary screen printer is one manner of practicing the invention. Sintering following the rotary screen printing is one manner of practicing the invention. The adhesive may be employed only in the usage regions, while the waste regions remain free of adhesive. Examples of component parts that may be manufactured in this way include sun roof panels, light fixtures, and other automotive parts.

The substrate used in this invention may be functionally graded in porosity. This means that the porosity of the substrate changes through the thickness of the sample. This can be seen in U.S. Patent Publication Number 2007/0275180 A1. When the adhesive powder is applied on the surface by employing a high concentration of finer denier binder fibers, there may be no requirement for a scrim to hold the adhesive powder on the surface for bonding operations. The elimination of the need for a functional scrim layer is a very desirable and cost effective feature of the invention in one embodiment.

Although the use of a K-12 High Loft Random Card machine manufactured by Fehrer A G (Linz, Austria) is one way to achieve such a functional fiber concentration gradient, the invention is not limited to any particular machine or manner of achieving such a gradient. In other embodiments of the invention, there may be variations in the concentration amount of bast or natural fibers across the width of the core layer, by size or by weight.

In one embodiment of the invention, the porosity of the first side of the core layer is less than the porosity of the second side of the core layer. That is, the first side of the layer tends to have a high concentration of fine denier fibers, whereas the second side of the core layer tends to have a higher concentration of coarse denier fibers. The first side is uniform, smooth, but still porous to air. The second side may be more rough, less uniform, less smooth, and yet still porous to air.

There are several advantages of using powder adhesives on composite substrates particularly used in automotive headliners. With regard to acoustics, the application of powder adhesive onto the composite surface desirably does not render the substrate impermeable. The acoustic performance of the substrate typically remains essentially the same before and after the application of the adhesive powder. In fact, the acoustic performance of the molded substrate can be tuned by the amount of powder adhesive added and the method of adhesive application. Since a low melt flow index polymer is used, the adhesive powder desirably stays on the surface as it softens and melts to provide an excellent bond between the foam or fabric, and the composite.

In typical headliner manufacturing operations, about 30% of the composite evolves as trim waste when an automotive headliner is molded. These sections are predetermined and do not require any adhesive to bond with the fabric as they will be cut away from the finished part. The use of a powder adhesive solution provides the flexibility to do a patterned deposition. As a result, sintered powdered adhesive is present only in sections where an adhesive bond is required, thereby minimizing waste of adhesives. This may reduce the cost of manufacturing such components.

When applying a powdered adhesive, care must be taken to engineer a composite surface that will form a suitable mechanical bond with a powdered adhesive. It is very important that the surface of the fiber composite structure be relatively smooth and uniform. If that is not the case, and a good adhesive bond is not achieved. If the surface of the composite is not uniform during manufacture, a scrim or a film layer is generally used to offer a uniform surface for adhesive application.

To employ a fiber-based composite that will be suitable for this application, with at least one uniform and smooth outer surface, one may choose a fiber-containing composite. It may be comprised of a “stratified” mixture of fibers that are air laid to form a “functional gradient” or stratified layers of deposited fibers in the composite. Thermoplastic fibers such as polypropylene fibers are used to promote fiber to fiber bonding of natural fibers together in a matrix. The concentration gradient among fiber types is also an optional feature of the invention, as further described herein.

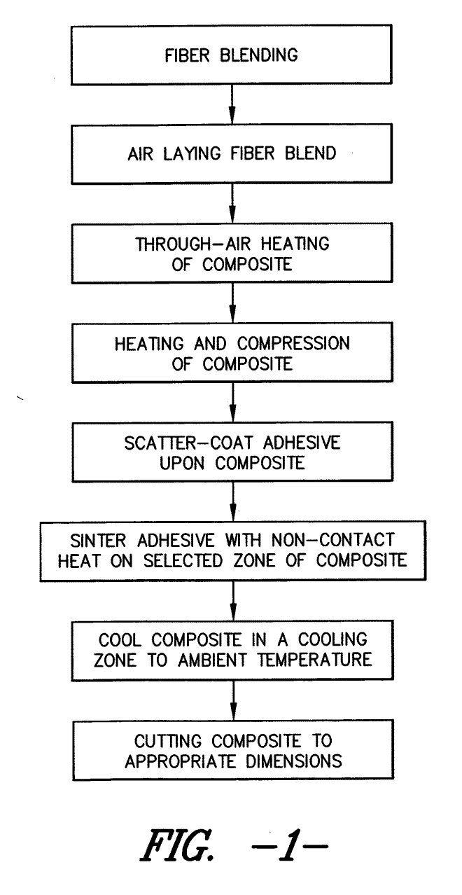

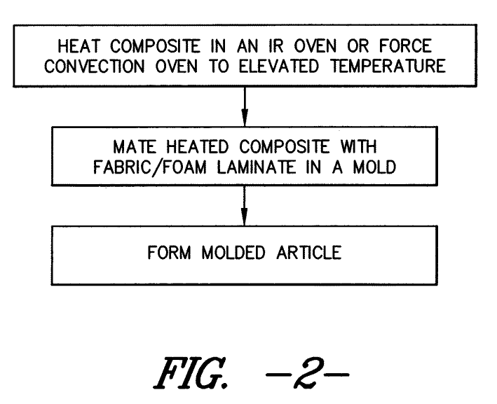

Referring to FIGS. 1 and 2, the steps in the practice of the invention are illustrated herein. Fibers are blended and then may be air laid into a non-woven composite structure. Through-air heating of the composite structure thus formed is useful, followed by heating and compression of the composite.

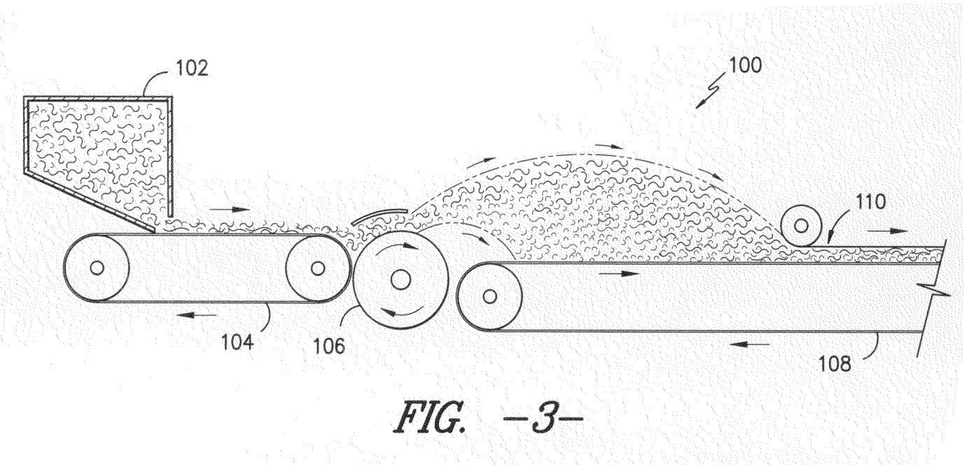

An apparatus suitable for performing the air laying portion of the core layer manufacturing method is depicted in FIG. 3. A commercially available piece of equipment that has been found to be suitable for carrying out the above-described method is the “K-12 HIGH-LOFT RANDOM CARD” by Fehrer A G (Linz, Austria). In the apparatus 100 depicted in FIG. 3, the binder fibers and bast fibers are blended in the appropriate proportions and introduced into a feed chute 102. The feed chute 102 delivers the blended fibers to a transverse belt 104 that delivers a uniform thickness or batt of fibers to an air lay machine comprising a cylinder 106. The cylinder 106 rotates and slings the blended fibers towards a collection belt 108. The collection belt 108 typically comprises a plurality of perforations in its surface (not shown) so that a vacuum can be drawn across the belt which helps the fibers to properly settle on the collection belt 108. The rotation of the cylinder 106 slings the fibers having a higher linear density a further distance along the collection belt 108 than it slings the fibers having a lower linear density. As a result, the unitary, fiber-containing composite 110 collected on the collection belt 108 will have a greater concentration of the fibers with a lower linear density adjacent to the collection belt 108, and a greater concentration of the fibers with a higher linear density further away from the collection belt 108. In general, the larger the difference in linear density between the fibers, the greater the gradient will be in the distribution of the fibers.

FIG. 4 shows a further continuation of the process shown in FIG. 3, with heater 112 providing through-air heating of the high loft unitary fiber containing composite 110. The double belt press 114 applies heat and pressure to significantly compress composite 110 to form compressed composite 113. Powder scattering unit 116 applies powdered adhesive 119 from hopper 118 to the compressed composite 113. This is followed by heating of the core layer using a non-contact heat source 120 to sinter the adhesive 119, thereby forming composite 122 with sintered adhesive. A cooling zone 124 reduces the temperature, so that porous unitary fibrous composite 128 at or near ambient temperature may be cut to size with knife 126.

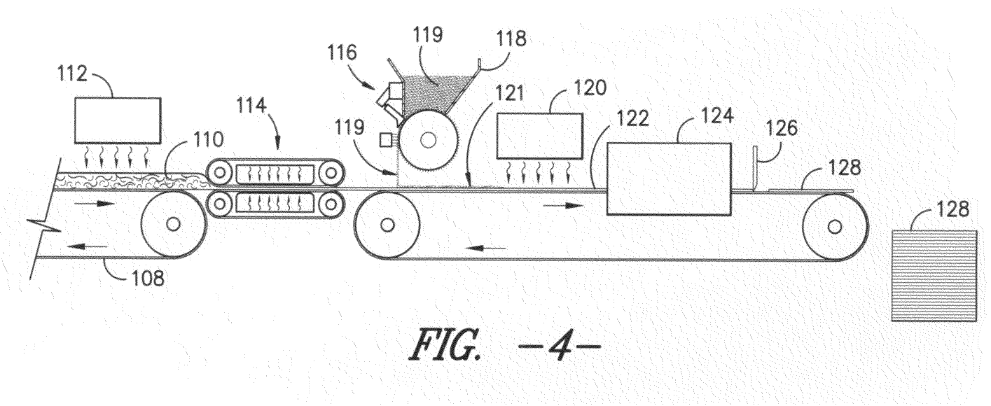

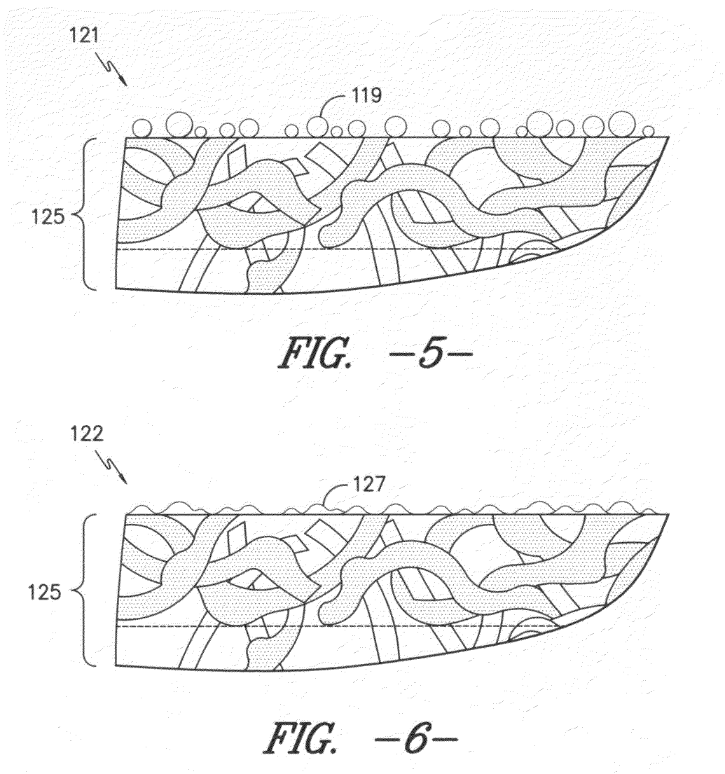

FIG. 5 shows one embodiment of the invention (as previously seen in FIG. 4) showing composite 121 with unsintered adhesive 119 on the surface of core layer 125. FIG. 6 shows composite 122 with sintered powdered adhesive 127 on the surface of core layer 125.

FIG. 7 is an illustration of yet another embodiment of the invention which employs a functional fiber concentration gradient. Porous unitary fibrous composite material 131 is illustrated by first side 133 and second side 134, with core layer 135 between. Sintered powdered adhesive 136 may be seen on the first side 133. Fine denier thermoplastic binder fibers 138 are numerous adjacent to the first side 133, and bast fibers 140 and coarse denier thermoplastic binder fibers 141 also are shown. FIG. 7 has a decorative fabric-foam laminate 147 comprising fabric 143 and foam 145 applied on its first side 133, as further described herein.

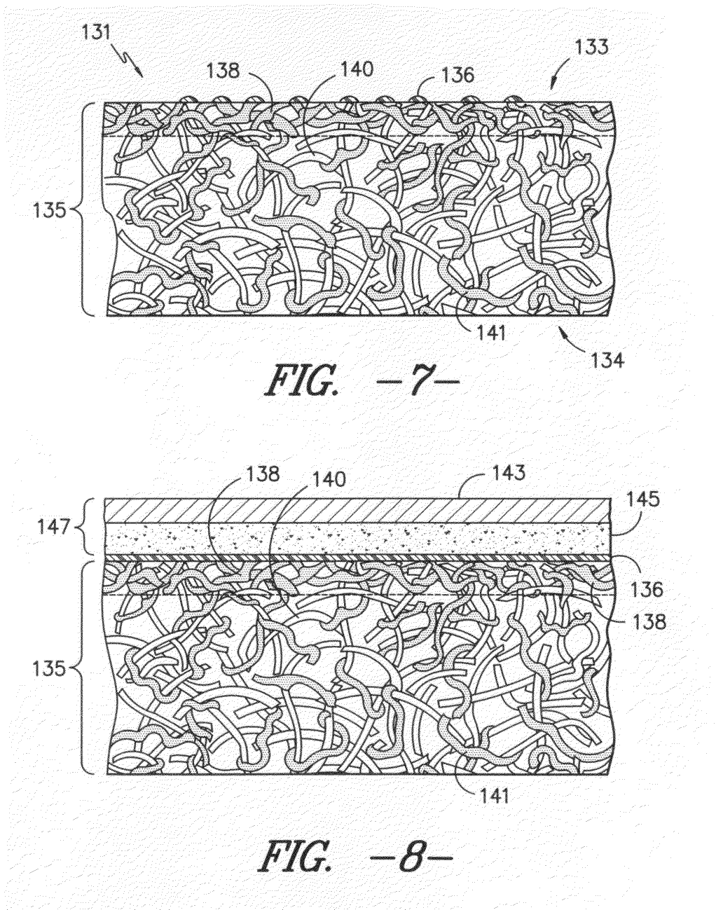

FIG. 8 shows another embodiment in which the composite structure of FIG. 7 has applied on its first side a fabric-foam laminate 147 comprising fabric 143 and foam 145, as further described herein.

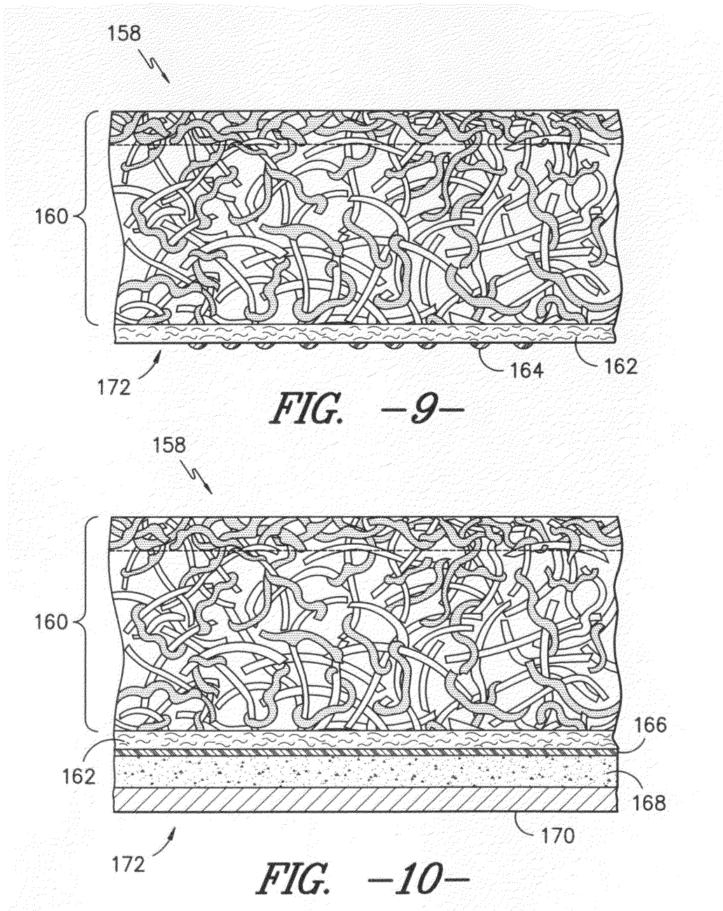

FIG. 9 shows an alternate embodiment of a porous unitary fibrous composite 158 with functional fiber concentration gradient, having core layer 160, further being defined by a scrim 162 attached to the second side 172. Powdered adhesive 164 is shown in its sintered state in FIG. 9, while FIG. 10 shows the molded composite with the adhesive layer 166 and foam 168 and fabric 170 bonded to the composite substrate.

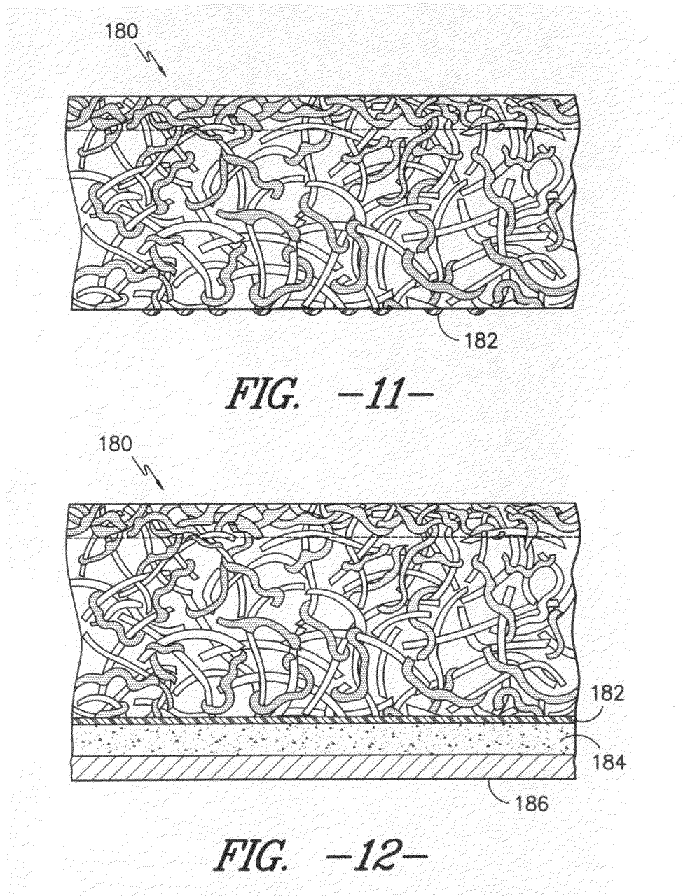

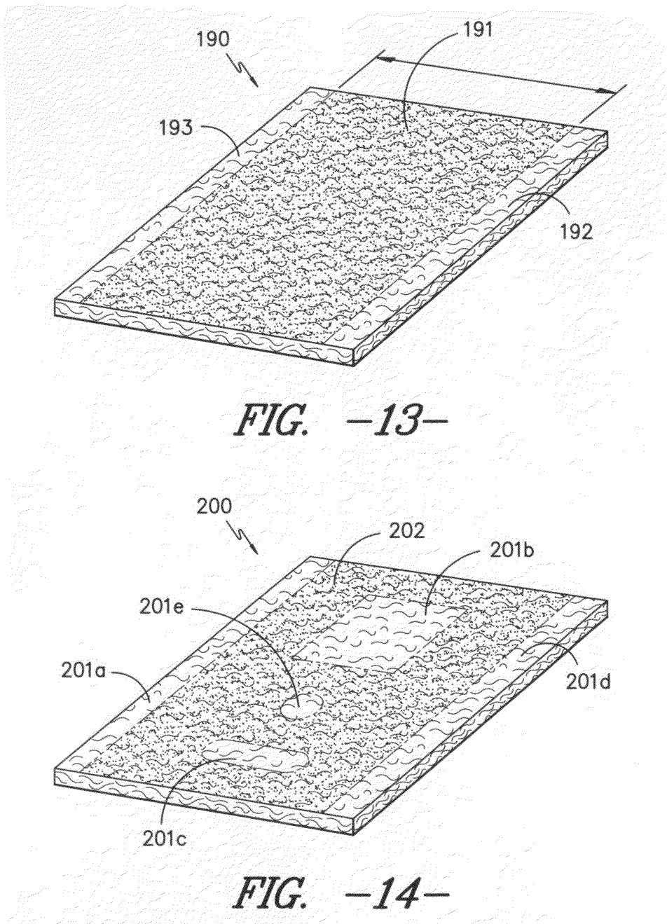

FIG. 11 shows an alternate embodiment of a porous unitary fibrous composite 180 with sintered powdered adhesive 182, and FIG. 12 shows the final construction after molding with the adhesive layer 182 covered by foam 184 and fabric 186.

FIG. 13 reveals an embodiment of the invention in which a porous unitary fibrous composite 190 is comprised of predetermined usage zone 191 and predetermined waste zones 192, 193 along the edges. The latter may be trimmed during final product completion.

FIG. 14 shows a porous, unitary fibrous composite with a patterned deposition of adhesive. The fibrous composite 200 with adhesive powder is a moldable composite sheet suitable for many applications, including automotive parts. Waste zones 201a-e which are cut away and discarded in final manufacture are shown. Usage zone 202 that contains the powder adhesive on the surface is also shown.

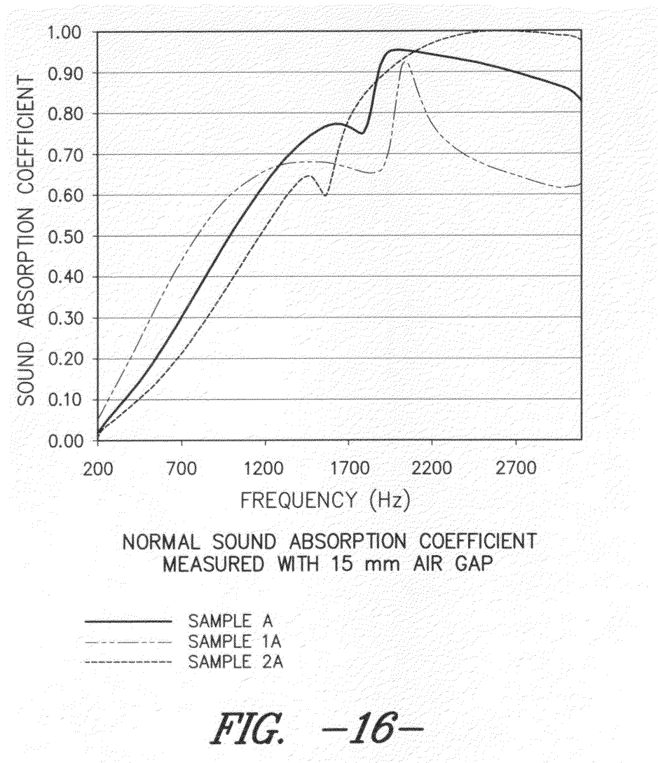

FIGS. 15-16 show normal sound absorption coefficients for components of the invention examples which are described herein.

### Example of Air Laid Methods of Core Layer Manufacture

This example demonstrates one method for producing a unitary, fiber-containing composite core layer. A fiber-containing composite core layer (Sample A) was produced by air laying a fiber blend using a K-12 HIGH-LOFT RANDOM CARD by Fehrer A G (Linz, Austria), as described herein. In particular, the composite was produced from a fiber blend containing approximately 45 weight % (based on the total weight of the fiber blend) of thermoplastic binder fibers and approximately 55 wt. % of kenaf fibers, which had a linear density of approximately 8. 8̅-2 dtex (8-18 denier). The binder fibers were polypropylene binder fibers containing polypropylene that had been grafted with approximately 10 wt. % maleic anhydride (MAH). The binder fiber content was comprised of four binder fibers having four different linear densities. The first binder fibers, which comprised approximately 15 wt. % of the total weight of the fiber blend, had a linear density of approximately 1.5 denier. The second binder fibers, which comprised approximately 10 wt. % of the total weight of the fiber blend, had a linear density of approximately 10 denier. The third binder fibers, which comprised approximately 10 wt. % of the total weight of the fiber blend, had a linear density of approximately 30 denier. The fourth binder fibers, which comprised approximately 10 wt. % of the total weight of the fiber blend, had a linear density of approximately 70 denier.

The above described fiber blend was air-laid onto a moving belt. Due to the difference in denier between the fibers contained in the fiber blend, the K-12 machine produces a functionally graded composite mat that contains a greater concentration of the 1.5 denier binder fiber on the side closest to the collection belt, a greater concentration of the 10 denier and 30 binder fibers in a middle region, and a greater concentration of the 70 denier binder fiber in the upper region. Due to the polydispersity of the kenaf fibers, they are non-uniformly distributed across the thickness of the substrate. Following the air laying step, the resulting composites were passed through a through-air pre-heat oven in which air heated to a temperature of approximately 175° C. (347° F.) was passed through the composite to partially melt the binder fibers in the core material.

Sample A was produced by passing a composite, which had been air laid so that it had a weight of approximately 1000 g/m², through a double-belt compression oven in which the belts were heated to a temperature of approximately 204° C. (400° F.). After passing through the compression oven, Sample A had a thickness of approximately 3.3 mm. Spunbond non-woven fabric nominally weighing 20 g/m² was laminated onto either one side or both sides of the core layer using the double-belt compression oven.

### Example of Adhesive Application to the Core Layer

A precision powder scattering unit (TechnoPartner Samtronic GmbH, Göppingen, Germany) was used to scatter powder adhesive onto the composite core layer described above. A funnel-shaped charging hopper is supplied with the powder adhesive. The powder adhesive is uniformly distributed inside the charging hopper and the level is kept constant during the scattering process. A special mixer is used to avoid cavity formation and decomposition of the material. A rotary metering roller with a cell size selected according to the grain size of the powder adhesive is fixed to the bottom side of the charging hopper. The powder adhesive is picked up by the metering roller and stripped at a flexible doctor blade, after which it is conveyed to an oscillating brushing device for transfer to the subjacent substrate line carrying the composite core.

Composite sheet Sample 1 was prepared by scattering adhesive powder (see Table 1) onto Sample A (described above) using the precision powder scattering unit, and then passing it through a belt laminator configured at the right temperature, pressure and speed to laminate the powder adhesive onto the core layer. Sample 1 is still porous as the powder adhesive forms a broken film on the surface of the core layer, however the combination of contact heat and pressure forces some of the powder adhesive into the thickness of the composite making it unavailable for surface adhesion.

Composite sheet Sample 2 was prepared by scattering adhesive powder (see Table 1) onto Sample A (described above) using the precision powder scattering unit, and then passing it through Infra-red (IR) heating banks configured to heat the composite surface to a temperature of 350 F. The residence time of the composite sheet under the IR banks is approximately 15 seconds. The application of non-contact heat using the IR banks, melts the outside of the powder adhesive fusing it to the porous substrate underneath, creating a three-dimensional “standing” adhesive layer as opposed to a two-dimensional adhesive layer formed when using laminated powder or film adhesives. Sample 2 is still porous and retains majority of the powder adhesive on the surface of the core layer. The porosity and the air-flow resistance of the composite sheet can be controlled by the amount of powder adhesive added.

### Composite Molding and Peel Strength Measurements

The porous composite sheet Samples 1 and 2 were clamped in a pin frame with the powder adhesive surface facing up and subjected to heating in a two-stage IR heating oven, with the pre-heat oven having a top and bottom set-point temperature of 415 F. and 400 F. respectively, and the final stage oven having a top and bottom set-point temperature of 405 F. and 390 F. respectively. The residence time in the oven was controlled to ensure homogeneous heating of the composite substrate and to achieve a core temperature of at least 365 F. At this stage, the powder adhesive is fully melted and stays on the surface of the composite sheet (especially in Sample 2). The heated substrate is then conveyed onto a molding tool that is maintained at a constant temperature, when a 3.5 mm thick polyurethane foam—woven fabric decorative laminate is introduced onto the adhesive surface. The time taken to convey the heated substrate from the oven to the molding station and the closing speed of the molding tool were optimized to provide the right bond-line temperature for attachment of the decorative fabric onto the composite sheet. Typical dwell time inside the mold was around 45 seconds.

Samples 1 and 2 with different powder adhesive types (see Table 1) were molded under the same conditions (described above) and specimens for peel strength measurements were sectioned off from the molded samples. The peel strength measurements (GMW14892 test method) were used to quantify the adhesive strength between the polyurethane foam and the composite sheet containing the powder adhesive. General Motor's GMW14892 material specification defines the adhesion requirements for bonded parts subjected to automotive interior environments. It specifies that the bonded adherends must meet the minimum peel strength of 26 N/5 cm or cohesive failure of one or both of the adherends.

The specimens for peel adhesion tests measured 152 mm in length and 50 mm in width. The samples were tested on a calibrated universal tester (Instron/ Model 4442) with a cross-head capable of traversing in the vertical direction at constant speeds. The polyurethane foam backed fabric laminate was carefully peeled from one side to allow the specimen to be mounted in the grips of the universal testing machine. The specimen was appropriately mounted to allow the bonding surfaces to be peeled at an angle of 180 degrees with a constant rate of 200 mm/min jaw separation. The force required to separate the bonding surfaces and the distance the foam peeled off from the substrate was recorded. A load vs. peel distance curve was constructed and the peel strength of the foam to the adhesive powder layer was calculated by integrating the area under the curve and reported with Newton/5 cm as the units for measurement. Eighteen specimens were tested for each powder adhesive type and coating method and peel strength measurements were made 1 hour and 5 days after fabric attachment. The experiment was sized to have a good probability of detecting a 2 N/5 cm difference in average peel strength after a delay of 5 days between different adhesive types and coating methods.

TABLE 1
Powder Adhesive Types and Method of Application

| | | Amount | | Average peel | | % Foam | |
|---|---|---|---|---|---|---|---|
| | | of | | strength | | failure | |
| | | adhesive | Mode of | (N/5 cm) | | 1 | 5 |
| Sample | Adhesive type | (g/m²) | application | 1 hour | 5 days | hour | days |
| 1A | EMS Griltex D ™ | 60 | Lamination | 17.74 | 12.29 | 29.2 | 16.7 |
| | 1556A P1-5 | | | | | | |
| 1B | EMS Griltex D ™ | 100 | Lamination | 18.00 | 13.07 | 14.8 | 0 |
| | 1556A P1-5 | | | | | | |
| 1C | EMS Griltex 11A ™ | 60 | Lamination | 21.25 | 15.10 | 25.0 | 4.2 |
| | P1-5 | | | | | | |
| 1D | EMS Griltex D ™ | 60 | Lamination | 15.24 | 11.87 | 4.8 | 0 |
| | 1519E P1-5 | | | | | | |
| 2A | EMS Griltex D ™ | 60 | Sintering | 25.19 | 21.61 | 70.4 | 51.9 |
| | 1556A P1-5 | | | | | | |
| 2B | EMS Griltex D ™ | 100 | Sintering | 28.57 | 25.94 | 100 | 100 |
| | 1556A P1-5 | | | | | | |
| 2C | EMS Griltex 11A ™ | 60 | Sintering | 27.67 | 25.62 | 70.4 | 29.6 |
| | P1-5 | | | | | | |
| 2D | EMS Griltex D ™ | 60 | Sintering | 24.97 | 14.36 | 44.4 | 0 |
| | 1519E P1-5 | | | | | | |

Ideally, the peel tear occurs at the interface of the foam and the composite substrate. When the bond strength between the foam and composite substrate is stronger than the bond strength between the foam and fabric, the peel strength number generated is actually the strength of the bond between foam and fabric. The foam remains bonded to the board, and the fabric peels away from the foam. This is recorded as “foam tear” and the percentage of foam failures in the samples tested is reported in Table 1. There is no completely rigorous statistical method for determining the true bond strength in the event of a foam tear. We analyzed the distribution of the peel strength measurements with foam tear and with no foam tear. Separate histograms were constructed for the 1 hour and 5 day measurements. We chose to use the 95^{th} percentiles of the no foam tear values to substitute for the measurements for those peel strength values having a foam tear. The updated values, while not exact, serve as a better representation of the bond strength when foam tear occurs during peel strength measurements. In the average peel strength measurements reported in Table 1, the 1 hour peel strength was replaced by 28.57 N/5 cm and the 5 day peel strength was replaced by 25.94 N/5 cm, if foam-tear occurred during the measurement. For peel strength measurements made after an hour and 5 days of fabric attachment, the sintered adhesive (this invention) gave statistically better average peel strengths than the laminated adhesive for all adhesive types. Also, Samples 2A and B with the sintered Griltex D 1556A P1-5 adhesive recorded the highest percent of foam failures.

### Sound Absorption Measurements of Composite Material

Here, we present the acoustical performance of composite Samples A, 1A and 2A. All three samples were run through the molding cycle (described above) and pressed to the same thickness using a flat mold press without any foam-fabric laminate attached to the surface. The normal incidence sound absorption of the composite substrates was obtained according to the ASTM E1050 standards via impedance tube measurements with 1) no air gap between the specimen and the back plate and, 2) 15 mm air gap between the specimen and the back plate. The acoustical measurements were made using a two microphone Bruel and Kjaer (B&K) type 4206 A impedance measurement tube. Plane waves were generated in the tube by a broadband, stationary, random noise source powered by a B&K type 2716C power amplifier, and standing waves in the tube were measured at two fixed locations using calibrated microphones. By measuring the sound pressure at two fixed locations and calculating the complex transfer function using a two-channel digital frequency analyzer (B&K 3560C), the complex reflection coefficient, the sound absorption coefficient and the normal acoustic impedance of the composite material was obtained. The samples for the impedance tube measurements were die cut to 63.5 mm diameter to fit the medium impedance tube specifically designed to measure the sound absorption coefficient in the frequency range 100 Hz to 3200 Hz.

At the same basis weight, the molded thickness, the amount of powder adhesive added and the method of adhesive application are all variables that can be tuned to tailor the porosity and the air flow resistance of the molded composite sheet to provide optimized sound absorption across a desired range of frequencies. The porosity and the air flow resistance of Sample A was changed by laminating or sintering powder adhesive onto its surface (Sample 1A, Sample 2A respectively). As laminating the powder adhesive forms a broken film on the surface of the core layer, the porosity of Sample 1A is lower than Sample 2A and Sample A. A representative plot of the effects of varying the overall porosity of the composite sheet on sound absorption is shown in FIGS. 15-16. In general, the sound absorption coefficients are better at lower frequencies for lower porosity levels (higher air flow resistance, Sample 1A). A cross over is observed to higher sound absorption at higher frequencies as the porosity of the composite increases (air flow resistance decreases, Sample 2A and Sample A).

Thus, it may be seen that the invention may be adapted to solve problems relating to the demand for quiet vehicle interiors. Acoustic requirements for interior trim components used in vehicles are greater than in the past, and materials used for trim components in the automobile industry must be more robust acoustically. Composite substrates that may be tuned to specifically absorb sound in a select range of frequencies, and thereby reduce noise, are desirable.

1. A porous unitary fibrous composite material comprising:
(a) a core layer comprising thermoplastic binder fibers and structural fibers, the core layer having a first side and a second side, wherein the first side is comprised in part of fine denier thermoplastic binder fibers, wherein the second side is comprised in part of coarse denier thermoplastic binder fibers, and wherein a functional fiber concentration gradient based on fiber denier extends from the first side to the second side of the core layer, and
(b) a sintered powdered adhesive upon at least the first or second side of the core layer.

2. The composite material of claim 1 wherein the sintered powdered adhesive is located upon the first side of the core layer.

3. The composite material of claim 1 wherein the sintered powdered adhesive is located upon the second side of the core layer.

4. The composite material of claim 1, wherein the porosity of the first side of the core layer is less than the porosity of the second side of the core layer.

5. The composite material of claim 1 wherein the structural fibers comprise bast fibers.

6. The composite material of claim 2 further comprising a fabric-foam laminate structure adhered to the first side of the core layer, wherein the sintered powdered adhesive is positioned substantially between the fabric-foam laminate and the core layer.

7. The composite material of claim 3 further comprising a fabric-foam laminate structure adhered to the second side of the core layer, wherein the sintered powdered adhesive is positioned substantially between the fabric-foam laminate and the core layer.

8. The composite material of claim 1 further comprising a scrim upon the core layer.

9. The composite material of claim 8 wherein a fabric-foam laminate structure is adhered to the scrim upon the second side of the core layer, wherein sintered powdered adhesive is positioned substantially between the fabric-foam laminate and the core layer.

10. A porous unitary fibrous composite material comprising:
(a) a core layer comprising thermoplastic binder fibers and structural fibers, the core layer having a first side and a second side, wherein the first side is comprised in part of fine denier thermoplastic binder fibers, wherein the second side is comprised in part of coarse denier thermoplastic binder fibers, wherein a functional fiber concentration gradient based on fiber denier extends from the first side to the second side of the core layer, and
(b) a sintered powdered adhesive upon at least the first or second side of the core layer, wherein the sintered powdered adhesive comprises at least two different chemical components.

11. The composite material of claim 10 wherein the chemical components are selected from the group of polymers or copolymers consisting of: polyethylene, polypropylene, polystyrene, polyvinylchloride, polyethylene terephthalate, polycarbonate, and polyamide.

12. A patterned porous unitary fibrous composite material comprising:
(a) a core layer comprising thermoplastic binder fibers and structural fibers, the core layer having a first side and a second side, wherein the core layer comprises a predetermined usage zone and a predetermined waste zone on at least the first or second side of the core, and
(b) a patterned sintered powdered adhesive upon the core layer, wherein the sintered powdered adhesive is located substantially completely upon the predetermined usage zone of the core forming a patterned sintered powdered adhesive.

13-24. (canceled)

25. The patterned porous unitary fibrous composite material of claim 12, wherein the first side of the core is comprised in part of fine denier thermoplastic binder fibers, wherein the second side of the core is comprised in part of coarse denier thermoplastic binder fibers, and wherein a functional fiber concentration gradient based on fiber denier extends from the first side to the second side of the core layer.

26. The porous unitary fibrous composite material of claim 1, wherein the core layer comprises a predetermined usage zone and a predetermined waste zone on at least the first or second side of the core and the sintered powdered adhesive is located substantially completely upon the predetermined usage zone of the core forming a patterned sintered powdered adhesive.

27. The porous unitary fibrous composite material of claim 10, wherein the core layer comprises a predetermined usage zone and a predetermined waste zone on at least the first or second side of the core and the sintered powdered adhesive is located substantially completely upon the predetermined usage zone of the core forming a patterned sintered powdered adhesive.
